(19) United States
(12) Patent Application Publication
(10) Pub. No.: US 2008/0251774 A1
(43) Pub. Date: Oct. 16, 2008

(54) Automated winches

(76) Inventor: Edward O. Wendell, Kingsland, GA (US)

Correspondence Address: Edward O. Wendell, 826 E. Hilton Ave., Kingsland, GA, 31548, US

(21) Appl. No.: 11/783,450

(22) Filed: Apr. 10, 2007

(51) Int. Cl. B66F 3/14

(52) U.S. Cl. 254/223

(57) ABSTRACT

This invention relates to the automation of standard weld on type winches.

Truck trailers average 10 to 12 load straps all of which are 25 to 30 feet long. By incorporating on one end of the winches mandrel a circular adapter having the means for a driver to attach a battery operated drill the driver will no longer have to manually roll up the straps eliminating wrist area stresses while making the job safer, quicker and easier.

### BACKGROUND OF THE INVENTION

An object of the present invention is to provide trucks with automated winches.

### SUMMARY

The present invention (process) was designed for improving weld on winches.

The intention of the present invention is to help drivers who have long sought ways to make their jobs easier, safer and quicker.

Unlike todays manual weld on winches that are not only cumbersome and time consuming to operate they put unnecessary stresses on the wrist area that ultimately can contribute to carpal tunnel syndrome.

Automated winches solve these problems while making for a more desirable winch.

### BRIEF DESCRIPTION OF THE DRAWINGS

FIG. 1. Shows the side and end views of a standard weld on winch.

FIG. 2. Shows the side view of the adapter needed to bring about the process of automating a standard weld on winch.

FIG. 3. Shows the side views of a winch the adapter and power drill with drill bit.

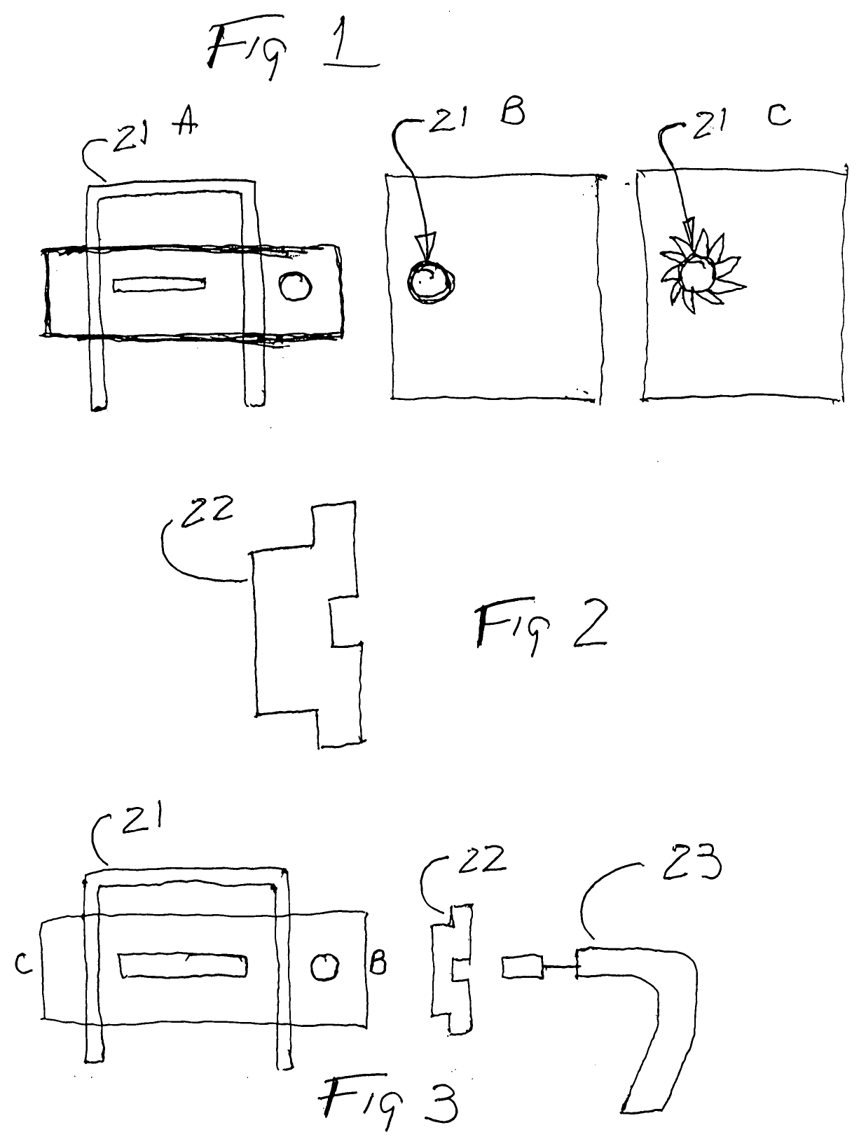

What is claimed:

1. (canceled)

2. (canceled)

3-5. (canceled)

6. The process for the automation of a standard weld on type winch comprising in combination
(A) A standard weld on type winch with on one end of the winches mandrel
(B) A circular adapter having means for the attachment of a power drill

7. a circular adapter having means for the attachment of a power drill this secures to the inner diameter of the mandrel of a standard weld on type winch automating the winch.
